(19) United States
(12) Patent Application Publication
(10) Pub. No.: US 2026/0330123 A1
(43) Pub. Date: Oct. 22, 2026

(54) ELEMENT LOCALIZATION FOR ASSISTED DOCUMENT EDITING

(71) Applicant: Adobe Inc., San Jose, CA (US)

(72) Inventors: Vlad Ion Morariu, Potomac, MD (US); Puneet Mathur, Sunnyvale, CA (US); Md mehrab Tanjim, Santa Clara, CA (US); Hammad Abdullah Ayyubi, New York, NY (US)

(73) Assignee: Adobe Inc., San Jose, CA (US)

(21) Appl. No.: 19/180,254

(22) Filed: Apr. 16, 2025

(51) Int. Cl. G06F 40/166; G06F 40/137; G06F 40/14; G06F 40/40; G06N 3/096

(52) U.S. Cl. CPC G06F 40/166; G06F 40/137; G06F 40/14; G06F 40/40; G06N 3/096

(57) ABSTRACT

In implementing techniques for element localization to perform assisted document editing, a processing device receives an edit request to edit an object in a document. A machine-learning model localizes a region of the document that corresponds to the object based on an image of the document and a description of the object in the edit request, the machine-learning model being trained to localize the region using a reward function for bounding box identifications of objects. The machine-learning model edits the object in the region based on the edit request to generate an edited region. The processing device presents an updated document that incorporates the edited region.

### BACKGROUND

Document editing and content creation tasks often involve modifying specific elements within a document. Users increasingly use artificial intelligence (AI) assistants to generate and edit particular sections, paragraphs, tables, links, multimedia elements, or other document elements based on natural language instructions. However, identifying and localizing the document elements referenced in user edit requests is challenging for conventional AI systems, especially when processing complex documents with hierarchical structures. Existing AI systems struggle to ground natural language instructions to the correct spatial locations within documents, leading to poor or inaccurate editing results.

### SUMMARY

Techniques and systems for element localization in assisted document editing are described. For example, an editing system receives an edit request as input to edit an object or element within a document. The input also includes an image of the document. In one example, the document is a Portable Document Format (PDF) document, and the edit request is received as a natural language description of the element to be edited and the edits to be performed (e.g., “remove data associated with the year 2002 from the second table”).

A machine-learning model of the editing system uses the inputs to localize a document region corresponding to the document element referenced in the edit request. The machine-learning model is trained using an autoregressive language modeling loss to learn the contextual relationship between document elements by predicting subsequent tokens based on preceding ones. This loss function allows the machine-learning model to capture spatial and semantic dependencies between different parts of a document, improving its ability to identify and localize elements referenced in edit requests accurately.

In one implementation, the machine-learning model is trained using a reward function to improve the model's accuracy in generating bounding boxes around document elements. The reward function combines an intersection over union (IOU) component, which measures the overlap between predicted and ground-truth bounding boxes, and a regression component, which measures coordinate differences. The described reward function enables more precise localization by balancing overall box alignment with fine-grained positional accuracy.

After identifying the relevant document region, the machine-learning model generates an edited version by performing the requested edit on the document element. The editing system then presents an updated document to the user that incorporates the edited region. The described editing system enables language-guided editing of documents without asking the user to locate and select elements manually.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ techniques and systems for element localization in assisted document editing as described herein.

FIG. 2 depicts a system in an example implementation showing operation of an editing module of FIG. 1 in greater detail.

FIG. 3 depicts an example of a diagram illustrating stages of element localization and element editing of documents.

FIG. 4 depicts a flow diagram depicting an algorithm as a step-by-step procedure for training a machine learning model according to aspects of the present disclosure.

FIG. 5 illustrates an example of an element localization process for assisted document editing.

FIG. 6 illustrates an example of adapting an LLM to generate synthetic training data for fine-tuning a multimodal LLM for document element localization.

FIG. 7 depicts a procedure in an additional example implementation of element localization for assisted document editing.

FIG. 8 illustrates an example system including various components of an example device that can be implemented as any type of computing device as described and/or utilized with reference to FIGS. 1-7 to implement embodiments of the techniques described herein.

### DETAILED DESCRIPTION

### Overview

Editing documents with artificial intelligence (AI) assistants often involves modifying specific elements within a document based on natural language instructions. Using AI assistants to edit particular sections, paragraphs, tables, or other document elements involves accurately identifying and localizing the referenced document elements. This localization task is particularly challenging for documents with hierarchical structures (e.g., PDF documents), where document elements may be nested or have intricate spatial relationships with other components.

Existing AI assistants struggle to ground natural language instructions to the correct elements referenced in user edit requests. Conventional approaches often employ specialized techniques designed specifically for specific document types or utilize general-purpose multimodal language models pre-trained on images. However, these conventional approaches often cannot accurately localize referenced document elements, especially when applied to text-heavy documents. For example, specialized models often do not leverage the advanced natural language understanding capabilities of large language models, while general-purpose multimodal models often lack domain-specific knowledge for handling the hierarchical and compositional nature of document structures.

Techniques and systems for element localization in assisted document editing are described herein to address these limitations. The described techniques bridge the gap between the natural language understanding capabilities of large language models (LLMs) and the spatial awareness to provide accurate document element localization. In particular, the strengths of multimodal large language models (MLLMs) are combined with domain-specific training data and optimization techniques to enable more precise and reliable identification of document elements referenced in user edit requests.

The described techniques train a machine-learning model to enhance its spatial localization capabilities. For example, the editing system generates synthetic instruction-tuning data using a hierarchical spatial document representation derived from partially annotated datasets. In this way, the editing system creates a large, diverse dataset that captures the compositional and hierarchical nature of document structures for many document types. The editing system also uses code-based natural language inference to clean the synthetic training data by filtering out misaligned or erroneous data points.

The editing system then uses the cleaned training data to fine-tune the machine-learning model (e.g., an MLLM) for element localization. The fine-tuning techniques enable the machine-learning model to better interpret user edit requests in the context of document structures. In an example implementation, the editing system utilizes a loss function for reinforcement learning to improve bounding box localization. For example, a reward function that combines an IOU component, which measures the overlap between predicted and ground-truth bounding boxes, and a regression component, which measures coordinate differences, can be used. The machine-learning model learns to generate more accurate and precise bounding boxes for document elements using the loss or reward function.

The resulting machine-learning model effectively localizes document elements referenced in natural-language edit requests, enabling more accurate and efficient AI-assisted document editing. The described techniques apply to various document types, including PDFs and design templates, and can be integrated into different user interfaces, such as chat or voice interfaces on mobile devices.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Environment for Assisted Document Editing

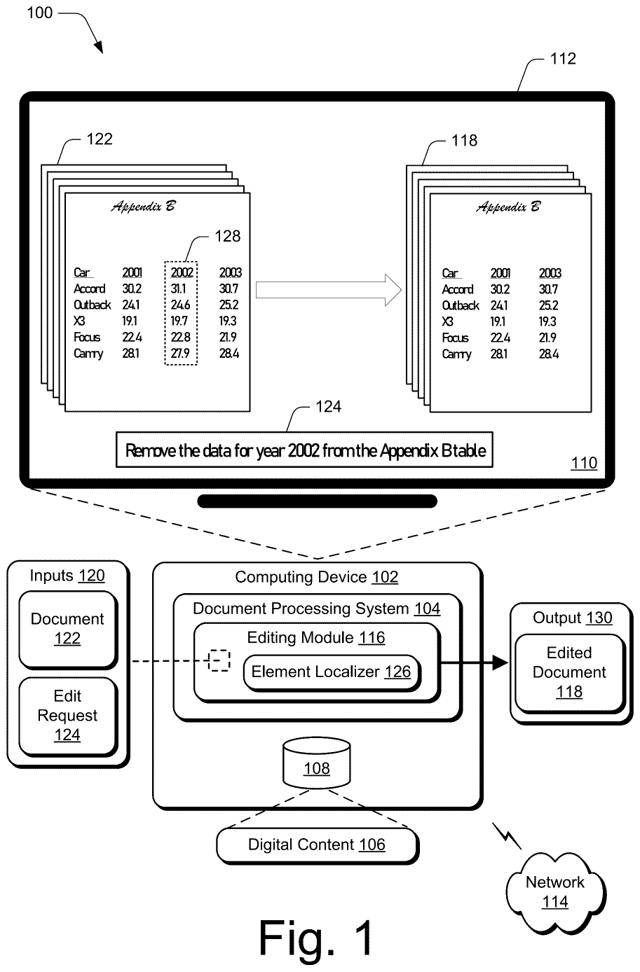

FIG. 1 is an illustration of a digital medium environment 100 in an example implementation that is operable to employ techniques described herein for element localization in assisted document editing. The illustrated digital medium environment 100 includes a computing device 102, which is configurable in various ways.

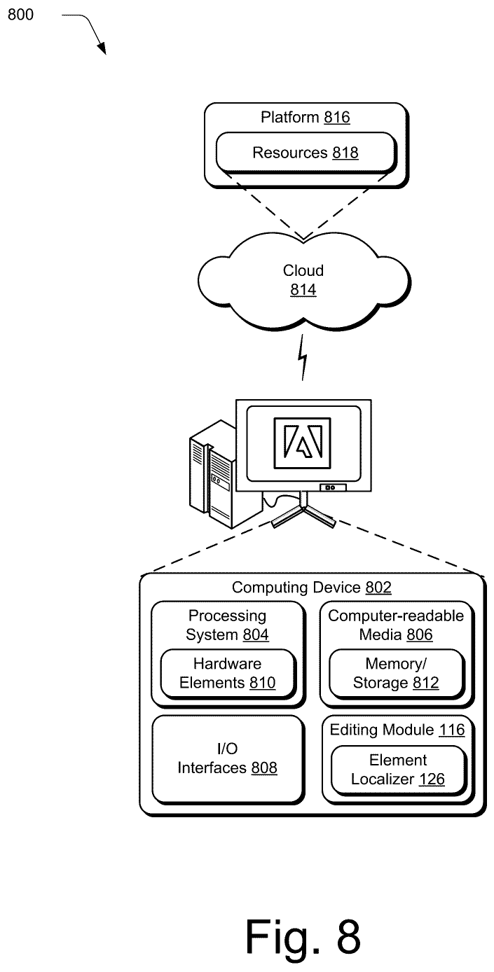

The computing device 102, for instance, is configurable as a desktop computer, a laptop computer, a mobile device (e.g., assuming a handheld configuration such as a tablet or mobile phone), an augmented reality device, and so forth. Thus, the computing device 102 may range from full-resource devices with substantial memory and processor resources (e.g., personal computers and game consoles) to a low-resource device with limited memory and/or processing resources (e.g., some mobile devices). Additionally, although a single computing device 102 is shown, the computing device 102 is also representative of a plurality of different devices, such as multiple servers utilized to perform operations “over the cloud” as further described in relation to FIG. 8.

The computing device 102 also includes a document processing system 104. The document processing system 104 is implemented at least partially in the hardware of the computing device 102 to create, represent, modify, and render digital content 106, which is illustrated as maintained in storage 108 of the computing device 102. The digital content 106 may be configured in various ways, such as web pages, word processing documents, spreadsheets, presentations, and so on. The document processing system 104 provides the user interface 110 via the display device 112, through which a user may interact with the digital content 106. Although illustrated as implemented locally at the computing device 102, functionality of the document processing system 104 is also configurable entirely or partially via functionality available via the network 114, such as part of a web service or “in the cloud.”

The computing device 102 also includes an editing module 116, which is illustrated as incorporated by the document processing system 104, that processes the digital content 106. In some implementations, the editing module 116 is separate from the document processing system 104, such as in an example in which the editing module 116 is available via the network 114.

The editing module 116 is configured to generate an edited document 118. For example, the editing module 116 receives an input 120 referencing a document 122 and an edit request 124. In this example, the document 122 is housed in storage, for instance, a cloud-based environment accessible by the editing module 116. The edit request 124 indicates a specific element or portion of the document 122 to edit. Examples of the edit request 124 include adding or removing characters from a body of text, adding a signature, adding or removing an image, changing font size, color, or style, or making other changes to the document 122.

As shown in this example, the input 120 includes a document 122, which is a multi-page PDF document featuring a table in Appendix B. An edit request 124 is received, which in this example includes a request to “remove the data for year 2002 from the Appendix B table.”

After receiving the document 122 and the edit request 124, the editing module 116 divides the elements of the document 122 into different regions that are visually distinct. In one example, one region is a block of text, a second region is a signature block, and a third region is a table. In other examples, the element is a page of the document 122, which is a multi-page PDF document. The editing module 116 uses an element localizer 126 to analyze the document 122 to identify the element(s) 128 referenced in the user edit request 124. In an implementation, the element localizer 126 localizes the element 128 by identifying or determining the precise location of the element 128 within the document 128. The localization process can include generating or identifying bounding box coordinates that define the spatial boundaries of the referenced element 128 within the document's layout. Localizing includes analyzing both the visual and semantic content of the document 122 to accurately map natural language descriptions to specific document elements 128. In this example, for instance, the element 128 being edited is a table column in Appendix B of the document 122. The element localizer 126 determines the location of element 128 within document 122 to enable editing by the editing module 116 to be applied to the correct portion of the document. The processed result is provided as output 130 in the form of edited document 118.

The element localizer 126 uses a trained machine-learning model to localize a region of the document 122 that corresponds to the element 128 referenced in the user edit request 124. The machine-learning model is configured to use an image of the document 122 and a user description of the element 128 in the user edit request 124 for localization.

In one implementation, the user interface 110 is configured to receive the user edit request 124 via a natural language interface. The natural language interface can include a chat or voice interface, which is particularly useful when implemented on a mobile device. This functionality allows users to edit the document 122 using natural language commands, enhancing accessibility and ease of use.

After processing the user edit request 124 and applying the edit, the document processing system 104 presents an updated document incorporating the edited element in the localized region of the document 122. The updated document is displayed on the display device 112, providing immediate visual feedback to the user. The editing module 116 is designed to handle various edit requests, from simple formatting changes to more complex structural modifications. For example, if a user requests to “move the third bullet point in the second list to the end of the first list,” the element localizer 126 identifies each list in the document 122, locates the second list, finds the third bullet point within that list, and identifies the first list. The editing module 116 then moves the specified bullet point to the end of the first list. This precision in element localization allows complex document editing operations to be performed automatically based on natural language user requests.

In one implementation, the element localizer 126 is trained offline. In another implementation, the element localizer 126 is configured to continuously refine its accuracy through machine-learning techniques (e.g., online learning). As the element localizer 126 processes more documents and edit requests, the underlying machine-learning model(s) can better understand document structures and interpret user intentions accurately.

In one implementation, the element localizer 126 is configured to seek clarification through the user interface 110 when encountering ambiguity in an edit request 124. For instance, if a user asks to “change the color of the heading,” and there are multiple headings in document 122, the element localizer 126 prompts the user for additional information to ensure the correct element is modified.

In another implementation, the editing module 116 and the element localizer 126 are configured to handle batch editing operations. For example, if a user requests to “change all instances of ‘company name’ to ‘New Company Inc.,’” the element localizer 126 identifies each occurrence of the specified text throughout document 122, and the editing module 116 applies the change universally.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Document Editing Process

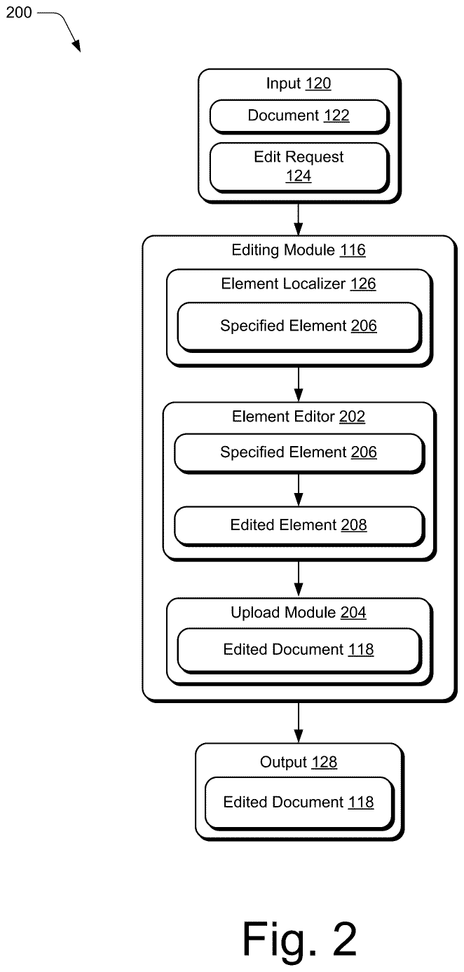

FIG. 2 depicts a system 200 in an example implementation showing operation of the editing module 116 of FIG. 1 in greater detail.

The following discussion describes techniques that are implementable utilizing the previously described systems and devices. Aspects of each of the procedures are implemented in hardware, firmware, software, or a combination thereof. The procedures are shown as a set of blocks that specify operations performed and/or caused by one or more devices and are not necessarily limited to the orders shown for performing the operations by the respective blocks. In portions of the following discussion, reference is made to FIGS. 1-8.

To begin, an editing module 116 receiving inputs 120, including a document 122 and an edit request 124. Document 122 includes various types of multimedia files, such as a multi-page PDF document, a design template, a slideshow, or a structured data file. Examples include a multi-page PDF document featuring tables and appendices, such as a financial report with data across multiple years, a design template for a marketing brochure with predefined sections for text, images, and company logos, and a structured data file containing hierarchical information, like an XML document describing product specifications and inventory levels.

The edit request 124 may include a wide range of modifications to the document 122, such as adding or removing characters from text, inserting signatures, manipulating images, or altering font properties. The requests can be received through various interfaces, including natural language text input via a chat interface or voice commands through a voice interface. For example, a user may submit an edit request to “remove the data for the year 2002 from the Appendix B table” or “move the third bullet point in the second list to the end of the first list.” The system is designed to handle simple formatting changes and complex structural modifications based on natural language user requests.

The editing module 116 includes the element localizer 126, an element editor 202, and an upload module 204 to process the inputs 120 and perform the requested edits. The element localizer 126 analyzes the document 122 and the edit request 124 to identify a specified element 206 referenced in the edit request 124. In accordance with the described techniques, the element localizer 126 generates a bounding box to localize the document element referenced in the edit request 124. This localization enables precise identification of the specific region of the document to be edited.

After the element localizer 126 identifies the specified element 206, the element editor 202 performs the requested edit to the specified element 206 to generate an edited element 208. The element editor 202 supports a wide range of editing operations, from simple text modifications to complex structural changes within the document 122. The element editor 202 can interpret and execute edit requests expressed in natural language, translating them into precise modifications of the specified element(s) 206. Users interact with the element editor 202 indirectly through natural language commands processed by the editing module 116. After performing the requested edits, the element editor 202 generates the edited element 208, representing the modified version of the specified element 206. This edited element 208 is then passed to the upload module 204 for integration into the edited document 118.

The upload module 204 receives the edited element 208 from the element editor 202 and incorporates it into the document 122 to create the edited document 118. In one implementation, the upload module 204 uses version control mechanisms to track changes and maintain document history. The upload module 204 interacts with document cloud storage or local storage to save the edited document 118, ensuring proper synchronization. In some implementations, the upload module 204 applies compression techniques to optimize storage and transmission of the edited document 118. The upload module 204 can also handle conflict resolution in scenarios where multiple edits are made to the same document simultaneously. The document editing process concludes with the editing module 116 producing the output 130, which includes the edited document 118.

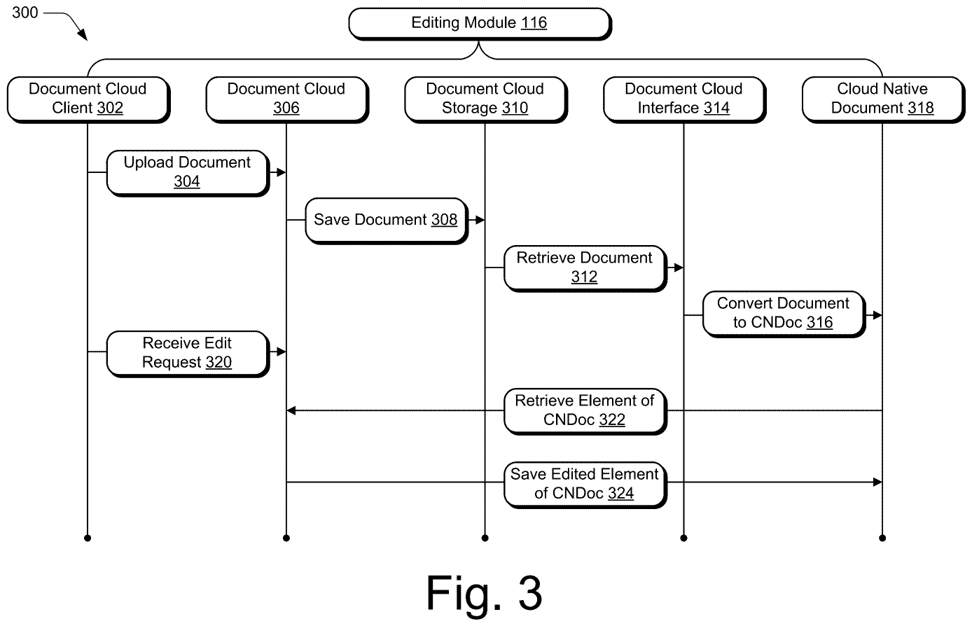

FIG. 3 depicts an example of a diagram 300 illustrating stages of element localization and element editing of documents.

The editing module 116 includes a document cloud client 302, which includes a user interface 110 for interaction with a document 122 in some examples. The document cloud client 302, for instance, includes software or an application that connects to a document cloud 306, which provides for storage, access, editing, and management of documents (e.g., PDF documents) online. The document cloud client 302 allows users to perform various operations, including uploading document(s) (block 304) to the document cloud 306. The document cloud 306 facilitates saving the document(s) (block 308) to a document cloud storage 310.

For example, the document cloud storage 310 is part of or communicatively coupled to the document cloud 306 and represents an online service that allows for storage, access, and management of documents on remote cloud servers instead of local devices. The document cloud storage 310, for example, is configured to facilitate retrieving the document (block 312) in response to a request from a document cloud interface 314. The document cloud interface 314 is a user-facing platform or API that allows for interaction with the document cloud storage 310 and also enables for uploading, storage, editing, management, and sharing of documents within a cloud environment of the document cloud storage 310. The document cloud interface 314 converts the document to a cloud-native document (CNDoc) (block 316), for instance, stored in the document cloud storage 310. The cloud-native document 318 is designed to be created, edited, managed, and stored directly in the document cloud storage 310, rather than being generated and modified on a local device. This optimizes the cloud-native document 318 for online collaboration, automation, and integration with cloud-based workflows.

For editing the cloud-native document 318 in this example, the document cloud client 302 receives an edit request for the document (block 320). The edit request specifies a change to an element of the document, which corresponds to the cloud-native document 318. After localizing the element of the cloud-native document 318 that corresponds to the edit, the element of the cloud-native document 318 is retrieved by the document cloud 306 from the document cloud storage 310 (block 322). The edit is then performed on the element, resulting in an edited element. Once edited, an edited element of the cloud-native document is saved to the cloud storage for later access (block 324).

The element localizer, which can use a multimodal large language model, operates within this architecture to accurately identify and localize document elements referenced in user edit requests. By leveraging the cloud-native document format and the efficient element-based editing operations, the element localizer can quickly process user requests and apply edits to the correct document elements. The described architecture enables a seamless workflow from document upload to cloud-based storage, conversion, editing, and saving. Integrating the element localizer within the framework allows for precise and efficient document editing based on natural language requests, leveraging the power of cloud computing and advanced language models even when users are on low-resource devices or devices that do not readily facilitate user inputs to make edits.

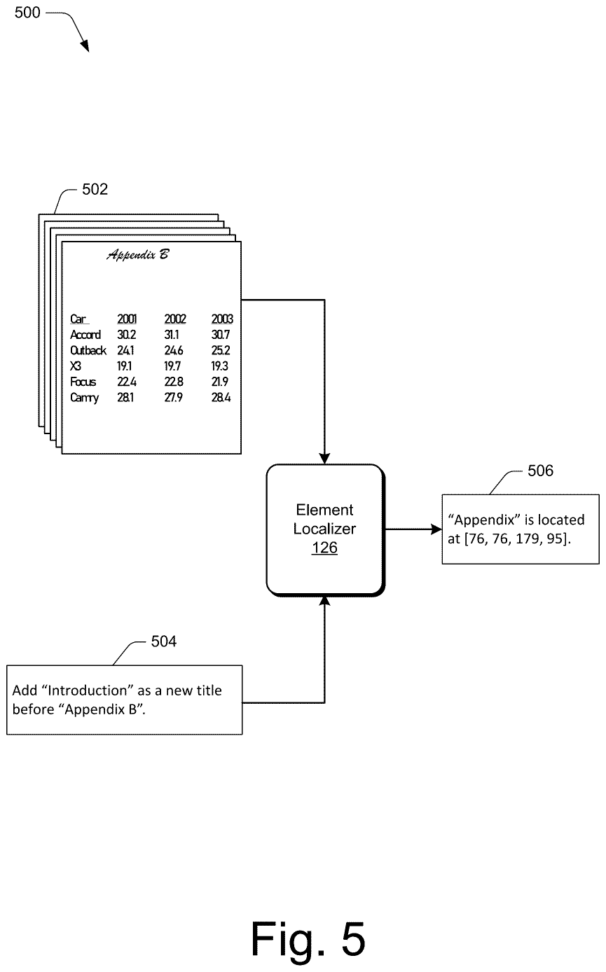

FIG. 5 illustrates an example 500 of an element localization process for assisted document editing. The element localization process utilizes the element localizer 126 (e.g., of FIGS. 1 and 2) to analyze document structure and incorporate user-specified edits to determine precise locations for document elements.

The element localizer 126 receives an image 502 of the document to be edited and a user edit request 504 as inputs. The element localizer 126 processes the image 502 to localize the document elements.

The user edit request 504 specifies the desired modifications to be made to the document. In the example shown in FIG. 5, the user edit request 504 includes an instruction to add “Introduction” as a new title before “Appendix B.”

The element localizer 126 processes the inputs to generate localization data 506, which specifies the precise location where the requested edit is to be applied within the document structure using bounding box coordinates. The coordinates are represented as a set of four values [x1, y1, x2, y2], where (x1, y1) defines the top-left corner of the bounding box and (x2, y2) defines the bottom-right corner. This rectangular representation enables the element localizer 126 to precisely identify the spatial boundaries of document elements such as paragraphs, tables, images, or headings. In this example, the element localizer 126 outputs localization data 506 that identifies the coordinates “[76, 76, 179, 95]” as the location where “Appendix B” is situated in the document. By using specific coordinates, the editing module targets the correct region for modification without affecting surrounding content, ensuring precise and accurate edits even in complex document layouts with multiple elements in close proximity.

### Example Training of Machine-Learning Model(s)

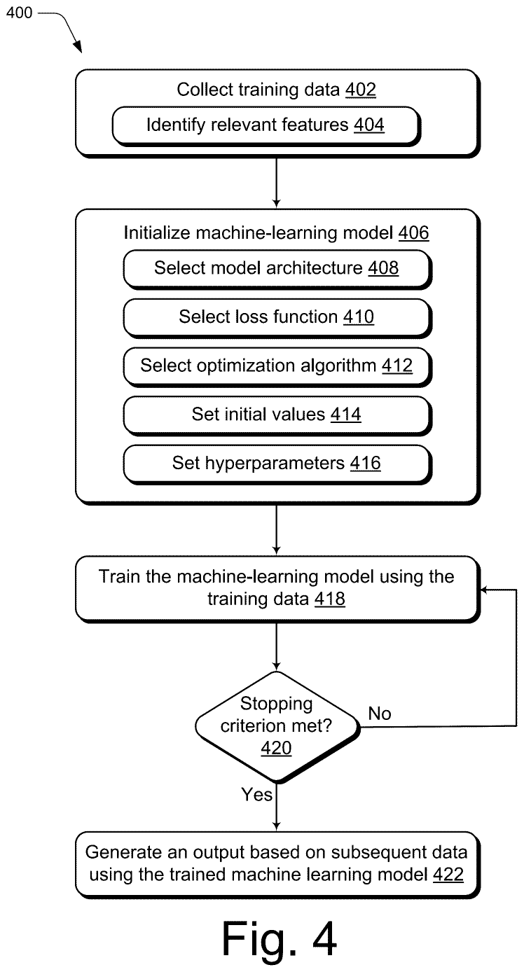

FIG. 4 is a flow diagram depicting an algorithm as a step-by-step procedure 400 in an example implementation of operations performable for training a machine-learning model. The procedure 400 provides one or more examples of generating training data, use of the training data to train a machine-learning model, and use of the trained machine-learning model to perform a task.

To begin in this example, a machine-learning system collects training data (block 402) that is to be used as a basis to train a machine-learning model, i.e., which defines what is being modeled. The training data is collected by the machine-learning system from various sources. Examples of training data sources include public datasets, service provider system platforms that expose application programming interfaces (e.g., social media platforms), user data collection systems (e.g., digital surveys and online crowdsourcing systems), and so forth. Training data collection may include data augmentation and synthetic data generation techniques to expand and diversify available training data, balancing techniques to balance some positive and negative examples, etc.

The machine-learning system is also configurable to identify relevant features (block 404) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 406). Initialization of the machine-learning model includes selecting a model architecture (block 408) to be trained. Examples of model architectures include neural networks, MLLMs, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 410). The loss function is utilized to measure a difference between an output of the machine-learning model (i.e., predictions) and target values (e.g., as expressed by the training data) to be used to train the machine-learning model. Additionally, an optimization algorithm is selected (block 412) that will be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 414), examples of which include initializing weights and biases of nodes to improve efficiency in training and computational resource consumption as part of training. Hyperparameters are also set (block 416) that are used to control the training of the machine learning model, examples of which include regularization parameters, model parameters (e.g., several layers in a neural network), learning rate, batch sizes selected from the training data, and so on. The hyperparameters are set using various techniques, including the use of a randomization technique, the use of heuristics learned from other training scenarios, and so forth.

The machine-learning model is then trained using the training data (block 418) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from and make predictions on known data by analyzing training data to learn and relearn to generate outputs that reflect patterns and attributes expressed by the training data.

Examples of training types include supervised learning that employs labeled data, unsupervised learning that involves finding underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., using the selected loss function and backpropagation to optimize the performance of the machine-learning model to perform an associated task.

As part of training the machine-learning model, a determination is made as to whether a stopping criterion is met (decision block 420), i.e., which is used to validate the machine-learning model. The stopping criterion is usable to reduce the overfitting of the machine-learning model, reduce computational resource consumption, and promote the ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 420), the procedure 400 continues training of the machine-learning model using the training data (block 418) in this example.

If the stopping criterion is met (“yes” from decision block 420), the trained machine-learning model is then utilized to generate an output based on subsequent data (block 422). The trained machine-learning model, for instance, is trained to perform a task as described above and, therefore, once trained, is configured to perform that task based on subsequent data received as input and processed by the machine-learning model.

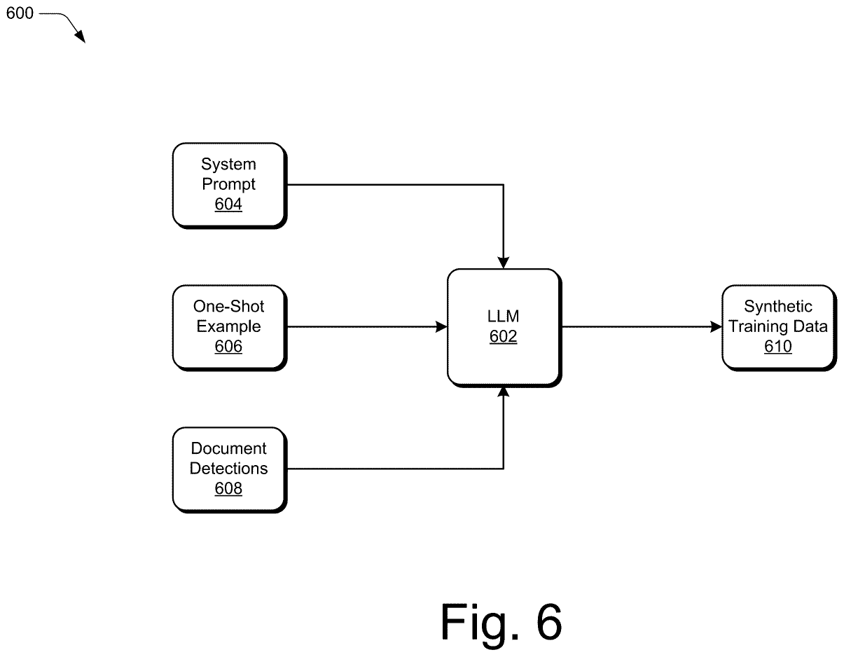

FIG. 6 illustrates an example 600 of adapting an LLM to generate synthetic training data for fine-tuning a multimodal LLM for document element localization. The example 600 includes a large language model (LLM) 602 that receives multiple inputs to generate a synthetic training dataset 610 for element localization tasks.

The LLM 602 receives as inputs a system prompt 604, a one-shot example 606, and document detections 608 as inputs. The system prompt 604 includes instructions and guidelines for the LLM 602 to follow when generating synthetic data. For example, the instructions specify the desired format, structure, and content of the generated data, ensuring that the output aligns with the element localization tasks. The one-shot example 606 provides an example or demonstration of the expected input-output behavior for the LLM 602 in the system prompt 604. This one-shot example 606 guides the LLM 602 in generating synthetic training data 610 by illustrating the desired format and content of both the input queries and the corresponding outputs.

The document detections 608 include information about various elements within the referenced documents, such as titles, paragraphs, lists, tables, figures, and captions. The document detections 608 are derived from multiple partially annotated datasets, each including annotations for different element types within the documents. A comprehensive representation of document structures and element types is obtained by combining diverse datasets. For example, the document detections 608 include hierarchical data that represents structured information about document elements, including their type, bounding box coordinates, and relationships. The hierarchical representation can include a tree structure that captures the spatial relationships between document elements such as titles, paragraphs, lists, tables, figures, and captions.

The LLM 602 processes the inputs to generate the synthetic training dataset 610, which includes many synthetic examples that pair user queries with corresponding document element localizations. The LLM 602 leverages its pre-trained knowledge and the provided inputs to create diverse and realistic scenarios for document element localization tasks. In particular, the LLM 602 analyzes document detections 608 to understand the structure and content of various document elements. Using this understanding, the LLM 602 generates synthetic user queries that reference specific document elements or regions and are designed to mimic real-world user requests for locating or editing document elements.

For each generated query, the LLM 602 also generates a corresponding localization output. The localization output specifies the precise location or bounding box of the referenced document element within the document. The LLM 602 ensures that the generated localizations accurately reflect the spatial relationships and hierarchical structure of the document elements as represented in the document detections 608.

The synthetic training dataset 610 generated by the LLM 602 undergoes a cleaning process using code-based natural language inference (Code-NLI) techniques. The cleaning involves generating code (e.g., using a language model such as GPT-4) to validate the alignment between the synthetic user queries and the corresponding document element localizations. The Code-NLI approach first translates natural language descriptions into executable code that can programmatically verify relationships between document elements and user requests. For example, if a user request mentions “the third paragraph in section 2,” the generated code checks whether the localized element is indeed the third paragraph and is contained within section 2 of the document.

The code also implements spatial reasoning functions that verify hierarchical relationships (parent-child, sibling), positional attributes (above, below, left, right), and semantic consistency between the request and the document structure. After code generation, the system executes this validation code against each synthetic data pair, computing an alignment score based on spatial and semantic correctness. Data pairs scoring below a predetermined threshold are filtered out, removing instances where the localization does not match the natural language description. The validation process ensures the quality and reliability of the synthetic training dataset 610, significantly improving the performance of models trained or fine-tuned on this data.

The cleaned synthetic training dataset 610 is then used to fine-tune a multimodal LLM (MLLM) for document element localization. The fine-tuning process adapts the MLLM to better understand and process the spatial and hierarchical relationships between document elements, enabling the element localizer 126 to accurately localize elements referenced in user queries.

During fine-tuning, the MLLM learns to map between natural language descriptions in edit requests and precise spatial coordinates within documents. The synthetic training dataset 610 provides diverse examples of document structures with varying complexity, teaching the model to recognize patterns across different document types, layouts, and element hierarchies. For instance, when a user requests to “remove the data for year 2002 from the Appendix B table,” the fine-tuned MLLM can identify both the semantic reference to “Appendix B table” and translate this into precise bounding box coordinates that localize the specific table column containing 2002 data.

The fine-tuning approach uses an autoregressive language modeling loss that enables the model to learn contextual relationships between document elements by predicting subsequent tokens based on preceding tokens. This loss function allows the model to capture spatial and semantic dependencies between different document parts, improving its accuracy in identifying and localizing elements referenced in user edit requests.

In another implementation, the fine-tuning approach employs a specialized reward function that balances two aspects of document element localization: semantic understanding and spatial precision. The semantic component ensures the model correctly interprets the user's intent and identifies the referenced element type (e.g., paragraph, table, image), while the spatial component optimizes the model's ability to generate accurate bounding box coordinates. The dual optimization enables the MLLM to handle ambiguous references like “the second paragraph after the introduction” by combining its understanding of document structure with precise spatial awareness.

The reward function includes an intersection over union (IOU) component and a regression component to improve bounding box localization. The IOU component calculates the overlap between the predicted bounding box and the ground truth bounding box, producing a score between 0 and 1, where 1 indicates exact overlap. The IOU metric effectively penalizes false positive and false negative regions, encouraging the model to precisely capture the referenced element without including extraneous area. The regression component measures the absolute coordinate differences between predicted and ground truth bounding boxes, providing fine-grained feedback on the exact positioning of the box corners.

The reward function is mathematically formulated as R=α·IOU+β·(1−NormalizedCoordinateDifference), where α and β are weighting parameters that control the relative importance of overlap versus precise coordinate prediction. The weighting parameters can be dynamically adjusted during training to emphasize different aspects of localization performance based on document type or element characteristics. For example, when localizing large elements like tables or figures, the IOU component might receive higher weight, while for smaller elements like specific words or characters, the regression component is given a higher weight.

During implementation, the reward function operates within a reinforcement learning framework where the MLLM receives immediate feedback on its bounding box predictions. This reinforcement learning approach allows the model to iteratively refine its spatial understanding through trial and error iteratively, gradually improving its ability to generate precise bounding boxes for various document elements.

The fine-tuning also employs a curriculum learning strategy where training progresses from simpler localization tasks (e.g., locating standalone headings) to more complex scenarios (e.g., identifying nested elements within hierarchical structures), with the reward function providing appropriate signals at each stage to guide the learning process. The described fine-tuning approaches enable the MLLM to achieve high precision even in complex document layouts with multiple overlapping or adjacent elements. The resulting fine-tuned model achieves significantly higher accuracy in document element localization than general-purpose MLLMs, particularly for text-heavy documents with complex hierarchical structures such as technical reports, legal documents, and financial statements.

By leveraging the LLM 602 to generate a large-scale synthetic dataset, the approach illustrated in FIG. 6 addresses the lack of large-scale annotated datasets for document element localization tasks. The combination of diverse inputs, including the system prompt 604, one-shot example 606, and document detections 608, enables the creation of a rich and varied dataset that captures the complexities of real-world document structures and user queries. The synthetic data generation process, coupled with the subsequent cleaning and fine-tuning steps, results in an MLLM optimized to handle document element localization tasks across a wide range of document types and user requests.

### Example Procedures

The following discussion describes techniques which are implementable utilizing the previously described systems and devices. Aspects of each of the procedures are implementable in hardware, firmware, software, or a combination thereof. The procedures are shown as a set of blocks that specify operations performed by one or more devices and are not necessarily limited to the orders shown for performing the operations by the respective blocks. In portions of the following discussion, reference is made to FIGS. 1-6.

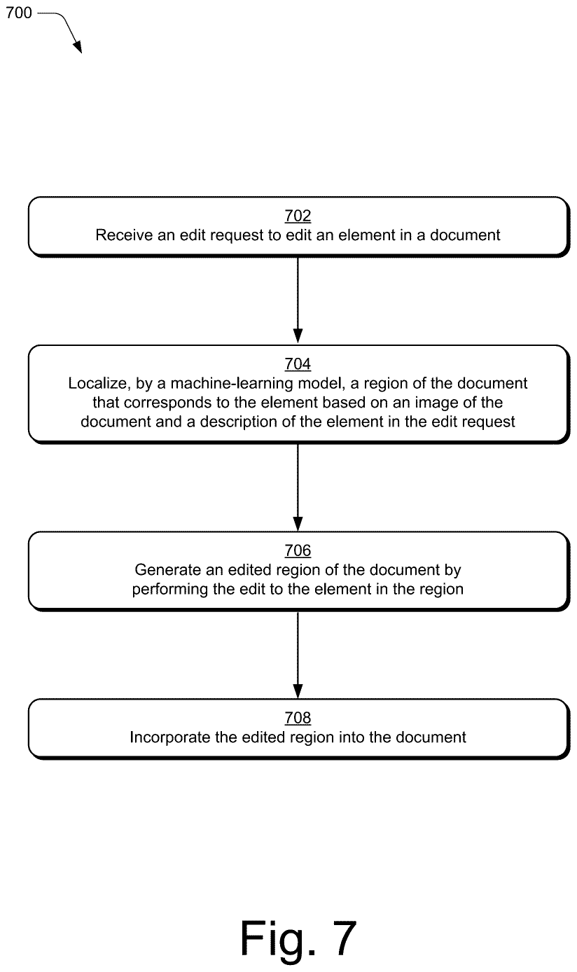

FIG. 7 illustrates a procedure 700 for performing document element localization and editing. To begin, an edit request is received to perform an edit to an element in a document (block 702). For example, the edit request specifies the desired changes to be made to a particular element within the document.

A machine-learning model localizes a region of the document that corresponds to the element specified in the edit request (block 704). The localization is performed based on an image of the document and a description of the element in the edit request. The machine-learning model is trained to localize regions of documents using a reward function for bounding box identifications of document elements. This reward function is designed to improve the bounding box localization capabilities of the model.

The reward function includes an IOU and regression component. The IOU component measures the overlap between predicted and ground-truth bounding boxes. The regression component measures coordinate differences between predicted and ground-truth bounding boxes. The reward function incorporating both components encourages the machine-learning model (e.g., an MLLM) to generate accurate and precise bounding box localizations for document elements.

In accordance with the described techniques, the machine-learning model is fine-tuned using cleaned synthetic training data. The cleaning includes generating code using a language model to validate alignment between one or more subparts of queries with the user requests. The generated code validates the training data by filtering out misaligned data. For example, executing the code removes synthetic data pairs where the generated query or a portion thereof does not align with the user request. By filtering out these misaligned instances, the quality of the training data is improved, leading to better performance of the machine-learning model in localizing document elements.

In one implementation, once the region is localized, the identified region of the document is downloaded from storage. The download ensures that the up-to-date version of the document content is available for editing.

An edited region of the document is generated by performing the edit to the element in the (downloaded) region of the document (block 706). For example, the editing module 116 applies the user-specified changes to the localized document element. The edited region is then incorporated into the document (block 708). For example, the editing module 116 presents the edited document in a user display.

### Example System and Device

FIG. 8 illustrates an example system generally at 800 that includes an example computing device 802 that is representative of one or more computing systems and/or devices that implement the various techniques described herein. This is illustrated through the inclusion of the editing module 116 and the element localizer 126. The computing device 802 is configurable, for example, as a server of a service provider, a device associated with a client (e.g., a client device), an on-chip system, and/or any other suitable computing device or computing system.

The example computing device 802, as illustrated, includes a processing system 804, one or more computer-readable media 806, and one or more I/O interface 808 that are communicatively coupled, one to another. Although not shown, the computing device 802 further includes a system bus or other data and command transfer system that couples the various components from one to another. A system bus includes any one or combination of different bus structures, such as a memory bus or memory controller, a peripheral bus, a universal serial bus, and/or a processor or local bus that utilizes various bus architectures. Various other examples are also contemplated, such as control and data lines.

The processing system 804 represents the functionality to perform one or more operations using hardware. Accordingly, the processing system 804 is illustrated as including hardware element 810 that is configurable as processors, functional blocks, and so forth. This includes implementation in hardware as an application-specific integrated circuit or other logic device formed using one or more semiconductors. The hardware elements 810 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically executable instructions.

The computer-readable storage media 806 is illustrated as including memory/storage 812. The memory/storage 812 represents memory/storage capacity associated with one or more computer-readable media. The memory/storage 812 includes volatile media (such as random-access memory (RAM)) and/or nonvolatile media (such as read-only memory (ROM), Flash memory, optical disks, magnetic disks, and so forth). The memory/storage 812 includes fixed media (e.g., RAM, ROM, a fixed hard drive, and so on) as well as removable media (e.g., Flash memory, a removable hard drive, an optical disc, and so forth). The computer-readable media 806 is configurable in various ways, as described below.

Input/output interface(s) 808 are representative of functionality to allow a user to enter commands and information to computing device 802 and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 802 is configurable in various ways, as described below, to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on various commercial computing platforms with various processors.

An implementation of the described modules and techniques is stored on or transmitted across some form of computer-readable media. Computer-readable media includes a variety of media that can be accessed by the computing device 802. By way of example, and not limitation, computer-readable media includes “computer-readable storage media” and “computer-readable signal media.” “Computer-readable storage media” refers to media and/or devices that enable persistent and/or non-transitory information storage in contrast to mere signal transmission, carrier waves, or signals per se. Thus, computer-readable storage media refers to non-signal-bearing media. The computer-readable storage media includes hardware such as volatile and non-volatile, removable and non-removable media and/or storage devices implemented in a method or technology suitable for storage of information such as computer-readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer. “Computer-readable signal media” refers to a signal-bearing medium configured to transmit instructions to the hardware of the computing device 802, such as via a network. Signal media typically embodies computer-readable instructions, data structures, program modules, or other data in a modulated data signal, such as carrier waves, data signals, or another transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware and hardware utilized to store instructions for execution, e.g., the computer-readable storage media described previously.

Combinations of the foregoing are also employed to implement various techniques described herein. Accordingly, software, hardware, or executable modules are implemented as one or more instructions and/or logic embodied on some form of computer-readable storage media and/or by one or more hardware elements 810. The computing device 802 is configured to implement particular instructions and/or functions corresponding to the software and/or hardware modules. Accordingly, implementation of a module that is executable by the computing device 802 as software is achieved at least partially in hardware, e.g., through use of computer-readable storage media and/or hardware elements 810 of the processing system 804. The instructions and/or functions are executable/operable by one or more articles of manufacture (for example, one or more computing devices and/or processing systems 804) to implement techniques, modules, and examples described herein.

The techniques described herein are supported by various configurations of the computing device 802 and are not limited to the specific examples of the techniques described herein. This functionality is also implementable through a distributed system, such as over a “cloud” 814 via a platform 816 as described below.

The cloud 814 includes and/or is representative of a platform 816 for resources 818. The platform 816 abstracts underlying functionality of hardware (e.g., servers) and software resources of the cloud 814. The resources 818 include applications and/or data that can be utilized when computer processing is executed on servers that are remote from the computing device 802. Resources 818 can also include services provided over the Internet and/or through a subscriber network, such as a cellular or Wi-Fi network.

The platform 816 abstracts resources and functions to connect the computing device 802 with other computing devices. The platform 816 also serves to abstract scaling of resources to provide a corresponding level of scale to encountered demand for the resources 818 that are implemented via the platform 816. Accordingly, in an interconnected device embodiment, implementation of functionality described herein is distributable throughout the system 800. For example, the functionality is implementable in part on the computing device 802 as well as via the platform 816 that abstracts the functionality of the cloud 814.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in various ways. Thus, individual functionality, features, and concepts described in relation to different example environments, devices, components, figures, and procedures herein are usable in any suitable combinations and are not limited to the particular combinations represented by the enumerated examples in this description.

What is claimed is:

1. A method comprising:
receiving, by a processing device, an edit request to edit an element in a document;
localizing, by a machine-learning model, a region of the document that corresponds to the element based on an image of the document and a description of the element in the edit request, the machine-learning model being trained to localize the region using a loss function for bounding box identifications of document elements;
editing, by the machine-learning model and based on the edit request, the element in the region to generate an edited region; and
presenting, by the processing device, an updated document that incorporates the edited region.

2. The method of claim 1, wherein the machine-learning model is a multimodal large language model fine-tuned using a training dataset, the training dataset being generated by:
generating, using a large language model, synthetic tuning data based on a hierarchical spatial document representation of example documents from one or more datasets, the synthetic tuning data including pairs of edits requests and corresponding output bounding boxes, the example documents being at least partially annotated with elements and bounding boxes; and
fine-tuning the machine-learning model using the synthetic tuning data.

3. The method of claim 2, wherein the hierarchical spatial document representation comprises a tree structure that includes multiple document elements and spatial relationships among the multiple document elements in the example documents.

4. The method of claim 3, wherein the multiple document elements include at least one of titles, paragraphs, lists, tables, figures, or captions.

5. The method of claim 2, wherein generating the training dataset further comprises cleaning the synthetic tuning data by:
generating, using the large language model, code to validate alignment between the edit requests and one or more portions of the synthetic tuning data; and
executing the code to filter out misaligned pairs.

6. The method of claim 1, wherein the loss function includes:
an intersection over union (IOU) component that measures overlap between predicted bounding boxes and ground-truth bounding boxes for the document elements; and
a regression component that measures coordinate differences between the predicted bounding boxes and the ground-truth bounding boxes.

7. The method of claim 1, wherein the document comprises a PDF document.

8. The method of claim 1, wherein the edit request is received in a natural language format.

9. The method of claim 8, wherein the edit request is received via a chat interface or a voice interface on a mobile device.

10. A system comprising:
a memory component; and
a processing device coupled to the memory component, the processing device configured to:
generate, using a large language model, training data based on a hierarchical spatial document representation of example documents from one or more datasets, the training data including pairs of edits requests and corresponding output bounding boxes, the example documents being at least partially annotated with elements and bounding boxes; and
generate a fine-tuned multimodal large language model (MLLM) using the training data and a loss function for bounding box identifications of document elements, the fine-tuned MLLM trained to localize the document elements referenced in edit requests by generating bounding boxes corresponding to the document elements.

11. The system of claim 10, wherein the hierarchical spatial document representation comprises a tree structure that includes multiple document elements and spatial relationships among the multiple document elements in the example documents.

12. The system of claim 11, wherein the document elements include at least one of titles, paragraphs, lists, tables, figures, or captions.

13. The system of claim 10, wherein the processing device is configured to clean the training data by:
generating, using the large language model, code to validate alignment between the edit requests and one or more portions of the synthetic tuning data; and
executing the code to filter out misaligned pairs.

14. The system of claim 10, wherein the loss function trains the fine-tuned MLLM to learn the contextual relationship between document elements by predicting subsequent tokens based on preceding tokens.

15. The system of claim 10, wherein the processing device is further configured to:
generate synthetic user edit requests based on the hierarchical spatial document representation; and
pair the synthetic user edit requests with corresponding document elements to create the training data.

16. The system of claim 10, wherein the processing device is further configured to apply a curriculum learning strategy to the fine-tuned MLLM, wherein the curriculum learning strategy progresses from simpler localization tasks to more complex localization tasks.

17. The system of claim 10, wherein the processing device is further configured to generate the training data using the large language model that receives as input a system prompt, a one-shot example, and document detections derived from the example documents that are partially annotated in the one or more datasets.

18. A non-transitory computer-readable storage medium storing executable instructions that, responsive to execution by a processing device, causes the processing device to perform operations comprising:
receiving an edit request to edit an element in a document;
localizing, by a machine-learning model, a region of the document that corresponds to the element based on a description of the element in the edit request, the machine-learning model being trained to localize the region using a loss function for bounding box identifications of document elements;
editing, by the machine-learning model and based on the edit request, the element in the region to generate an edited region; and
presenting an updated document that incorporates the edited region.

19. The non-transitory computer-readable storage medium of claim 18, wherein the loss function includes:
an intersection over union (IOU) component that measures overlap between predicted bounding boxes and ground-truth bounding boxes for the document elements; and
a regression component that measures coordinate differences between the predicted bounding boxes and the ground-truth bounding boxes.

20. The non-transitory computer-readable storage medium of claim 18, wherein the edit request is received in a natural language format via a chat interface or a voice interface.
